(19) United States
(12) Patent Application Publication
(10) Pub. No.: US 2026/0134095 A1
(43) Pub. Date: May 14, 2026

(54) AUTONOMOUS TRIPWIRE DEPLOYMENT DURING NETWORK PENTESTING

(71) Applicant: Horizon 3 AI, Inc., Dover, DE (US)

(72) Inventors: Naveen Sunkavally, Cary, NC (US); Snehal Antani, San Francisco, CA (US)

(21) Appl. No.: 18/947,246

(22) Filed: Nov. 14, 2024

(51) Int. Cl. G06F 21/55

(52) U.S. Cl. CPC G06F 21/554; G06F 2221/034

(57) ABSTRACT

A method of deploying tripwires autonomously is described. An autonomous pentesting agent may execute an autonomous penetration test of a network of network assets, where executing the autonomous penetration test includes identifying in real-time one or more network assets within the network to which one or more tripwires are to be deployed. The autonomous pentesting agent may deploy, during the autonomous penetration test, the one or more tripwires to the one or more network assets within the network based on one or more environmental factors of the one or more network assets detected during the autonomous penetration test. The autonomous pentesting agent may detect, after deploying the one or more tripwires, occurrence of a triggering event at a tripwire of the one or more tripwires and report the occurrence of the triggering event.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support autonomous tripwire deployment during network penetration testing (“pentesting”).

A method for tripwire deployment by an apparatus is described. The method may include executing an autonomous pentest of a network of network assets, wherein executing the autonomous pentest includes identifying in real-time one or more network assets within the network to which one or more tripwires are to be deployed, deploying, during the autonomous pentest, the one or more tripwires to the one or more network assets within the network based at least in part on one or more environmental factors of the one or more network assets detected during the autonomous pentest, detecting, after deploying the one or more tripwires, occurrence of a triggering event at a tripwire of the one or more tripwires, and reporting the occurrence of the triggering event based at least in part on the detection.

An apparatus for tripwire deployment is described. The apparatus may include one or more memories storing processor executable code, and one or more processors coupled with the one or more memories. The one or more processors may individually or collectively be operable to execute the code to cause the apparatus to execute an autonomous pentest of a network of network assets, wherein executing the autonomous pentest includes identifying in real-time one or more network assets within the network to which one or more tripwires are to be deployed, deploying, during the autonomous pentest, the one or more tripwires to the one or more network assets within the network based at least in part on one or more environmental factors of the one or more network assets detected during the autonomous pentest, detect, after deploying the one or more tripwires, occurrence of a triggering event at a tripwire of the one or more tripwires, and report the occurrence of the triggering event based at least in part on the detection.

Another apparatus for tripwire deployment is described. The apparatus may include means for executing an autonomous pentest of a network of network assets, wherein executing the autonomous pentest includes identifying in real-time one or more network assets within the network to which one or more tripwires are to be deployed, means for deploying, during the autonomous pentest, the one or more tripwires to the one or more network assets within the network based at least in part on one or more environmental factors of the one or more network assets detected during the autonomous pentest, means for detecting, after deploying the one or more tripwires, occurrence of a triggering event at a tripwire of the one or more tripwires, and means for reporting the occurrence of the triggering event based at least in part on the detection.

A non-transitory computer-readable medium storing code for tripwire deployment is described. The code may include instructions executable by one or more processors to execute an autonomous pentest of a network of network assets, wherein executing the autonomous pentest includes identifying in real-time one or more network assets within the network to which one or more tripwires are to be deployed, deploying, during the autonomous pentest, the one or more tripwires to the one or more network assets within the network based at least in part on one or more environmental factors of the one or more network assets detected during the autonomous pentest, detect, after deploying the one or more tripwires, occurrence of a triggering event at a tripwire of the one or more tripwires, and report the occurrence of the triggering event based at least in part on the detection.

### BRIEF DESCRIPTION OF THE DRAWINGS

FIG. 1 shows an example of a computing environment that supports autonomous tripwire deployment during network pentesting in accordance with aspects of the present disclosure.

FIG. 2 shows an example of an autonomous pentest map that supports autonomous tripwire deployment during network pentesting in accordance with aspects of the present disclosure.

FIG. 3 shows an example of a computing environment that supports autonomous tripwire deployment during network pentesting in accordance with aspects of the present disclosure.

FIG. 4 shows a diagram of a system including a device that supports autonomous tripwire deployment during network pentesting in accordance with aspects of the present disclosure.

FIG. 5 shows a flowchart illustrating methods that support autonomous tripwire deployment during network pentesting in accordance with aspects of the present disclosure.

### DETAILED DESCRIPTION

Tripwires (also referred to as honeytokens) refer to digital resources that are deployed to a network to attract malicious actors and detect security threats. A tripwire may be stored on a network asset (such as a real or virtual host machine) in the network. When a malicious actor accesses the tripwire, an alert is transmitted to a network administrator or a program monitoring for security events.

As an example, a tripwire may be a credentials file storing an invalid or expired username and password combination or access key. When a malicious actor attempts to access a network resource using the username and password combination or the access key, the network device receiving the username and password combination or the access key may trigger an event that alerts a network administrator or a security program that the tripwire has been tripped. Such an event may indicate that the host machine storing the tripwire has been compromised.

Other examples of tripwires may include business documents, database dump files, or modifications to a database or knowledge base.

By distributing tripwires throughout network assets in the network, a user may identify that an attacker is in the network. In some cases, a user may manually deploy tripwires. For example, a user may generate a tripwire (e.g., using a tool) and place the tripwire on a network asset in an environment identified by the user (e.g., subjectively). However, manually generated and deployed tripwires may be less convincing compared to other methods of tripwire deployment and time consuming for the user, leading to fewer and less effective tripwires being deployed. Alternatively, an automated system or tool may deploy tripwires. For example, a mass deployment tool may generate and place tripwires on network assets in the network based on a hard coded deployment process. However, the automated tripwire deployment may be associated with high resource overhead and complex deployment in a network and, as a result of the hard coded deployment process, may not be tailored to a specific network.

To address these and other issues, an autonomous penetration testing (“pentesting”) agent as described herein may deploy tripwires autonomously. For example, the autonomous pentesting agent may identify network assets to place tripwires on during an autonomous pentest, generate the tripwires according to the various environments of each of the network assets, and deploy the tripwires to the network assets. The autonomous pentesting agent may identify locations within the network (e.g., network assets and storage locations) where tripwires may be effective, including locations that are susceptible to compromise based on the autonomous pentest. In other words, the autonomous pentesting agent may identify a vulnerable network asset in real-time during the autonomous pentest (such as by compromising the network asset during the autonomous pentest or by identifying other environmental factors that make the network asset vulnerable to compromise during the autonomous pentest), and immediately and autonomously deploy a tripwire to that network asset based on compromising the network asset. The nature and quantity of tripwire(s) deployed to that network asset may vary based on the specific nature of one or more vulnerabilities or environmental conditions associated with the network asset. After deploying the tripwires, the autonomous pentesting agent may detect triggering events, either as a result of continued or subsequent autonomous pentesting, or as a result of malicious activity from the tripwires, and report occurrences of the triggering events.

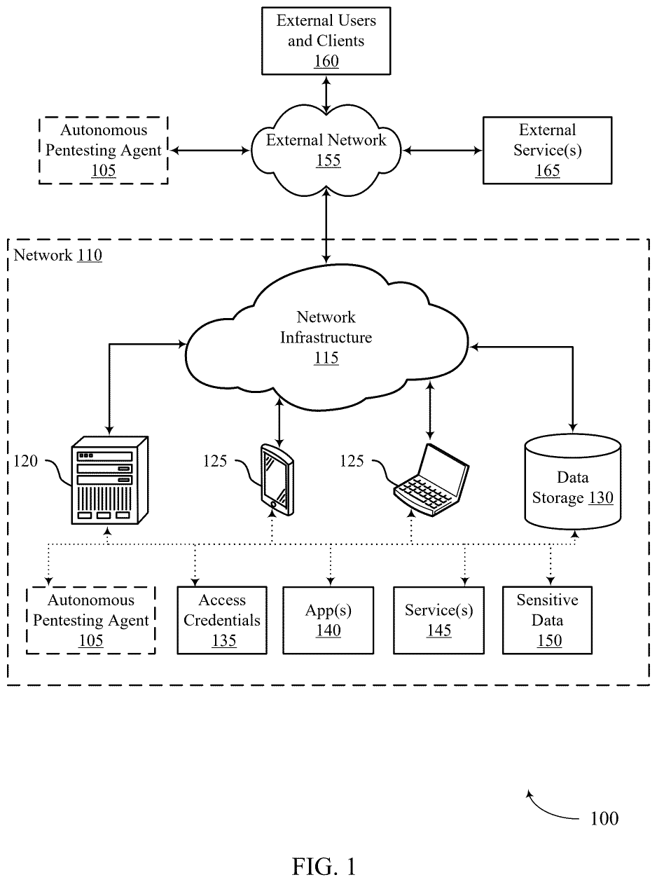

FIG. 1 illustrates an example of a computing environment 100 that supports autonomous tripwire deployment during network pentesting in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. As used herein, network assets refer to machines that include network shares. For example, network assets may be examples of machines (e.g., real or virtual machines) that include shares of the network 110, such as file sharing systems. Network assets may be obtained and utilized by attackers to compromise the network 110. The server 120, the computing devices 125, the data storage 130, and the access credentials 135, app(s) 140, service(s) 145, and sensitive data 150 accessible via the devices and systems of the network 110 may all be examples of network assets. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

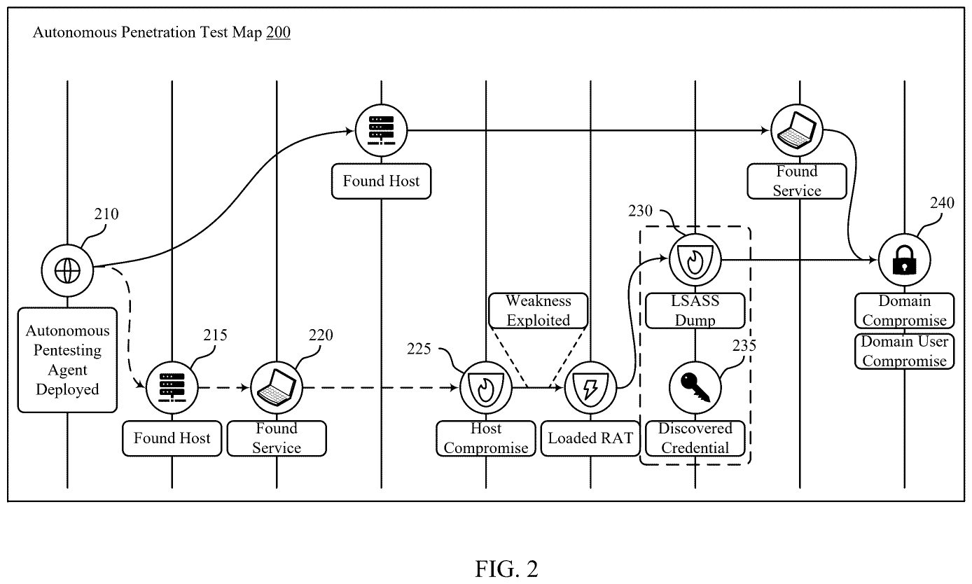

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, the autonomous pentesting agent 105 may autonomously deploy tripwires in the network 110. By generating and deploying tripwires using results from autonomous pentests, techniques described herein may support improved network security. For example, autonomously deployed tripwires may be more convincing to an attacker compared to a tripwire deployed via manual or automated deployment. The autonomously deployed tripwires may be more convincing based on the autonomously deployed tripwires being generated according to the results of the autonomous pentests, which may identify network features and characteristics (e.g., environmental or contextual characteristics) that the manual or automated deployment fail to identify. Because the autonomously generated tripwires are more convincing, the autonomous deployment may improve network security, as the tripwires may lure attackers at higher rates than tripwires that are deployed via manual or automated deployment. Tripwires that are autonomously deployed, compared to manually deployed or deployed via a mass deployment tool, may be placed at locations (e.g., on assets or locations within assets) where attackers may be more likely to encounter them. Placing tripwires at these locations may speed up a detection time when an attacker is in the network 110. For example, the more likely an attacker is to encounter a tripwire, the more likely the attacker is to trip the tripwire and be detected. Manually deploying tripwires may involve subjective decisions about where to place the tripwires, which may not align with where an attacker would be likely to encounter the tripwire. Deploying tripwires via a mass deployment tool may make deployment of tripwires obvious to an attacker, as an attacker may be more likely to identify the tripwires if a greater quantity are deployed. Additionally, autonomously deployed tripwires may be deployed using fewer resources (e.g., hardware resources, processing resources, etc.) compared to the manual or automated deployment. That is, compared to automated deployment involving a mass deployment tool that uses relatively large computational resources and is complex to install and integrate into the network, the autonomously deployed tripwires may be deployed during an autonomous pentest automatically.

FIG. 2 shows an example of an autonomous pentest map 200 that supports autonomous tripwire deployment during network pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 200 may include one or more types of events. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent pay perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support autonomous deployment of tripwires. For example, the autonomous pentesting service may autonomously deploy tripwires as a security measure according to the autonomous pentest map 200. That is, the autonomous pentesting service may deploy a tripwire at a host or service that was identified in the autonomous pentest map 200 as being included on a path to access 240 of an attacker to the network.

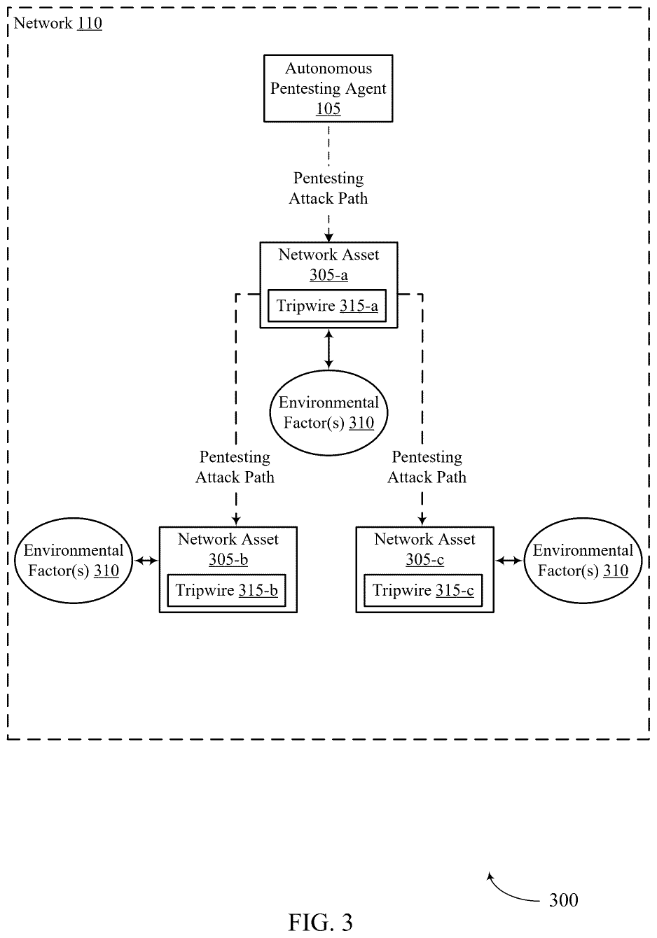

FIG. 3 shows an example of a computing environment 300 that supports autonomous tripwire deployment during network pentesting in accordance with aspects of the present disclosure. The computing environment 300 may implement or be implemented by the computing environment 100, the autonomous pentest map 200, or both. For example, the computing environment 300 may illustrate a network 110 that includes one or more network assets, including a network asset 305-a, a network asset 305-b, and a network asset 305-c. The network assets 305 may be examples of one or more devices or systems described with reference to FIG. 1, including the server 120, computing devices 125, data storage 130, access credentials 135, app(s) 140, service(s) 145, or sensitive data 150. Additionally, the computing environment 300 may include an autonomous pentesting agent 105, which may perform an autonomous pentest of the network 110. Although the autonomous pentesting agent 105 is shown as internal to the network 110 in the computing environment 300 of FIG. 3, the autonomous pentesting agent 105 may alternatively be external to the network 110 and access the network 110 via the Internet or another external network.

The autonomous pentesting agent 105 may generate and place tripwires in an autonomous manner within the network 110. In some examples, the autonomous pentesting agent 105 may use offensive security techniques. Offensive security techniques may refer to a type of cybersecurity directed to the TTPs used by real-world attackers to compromise networks. For example, TTPs may be used by attackers to inflict damage to the network 110 or obtain confidential information, such as to perform data theft, install ransomware, or generally disrupt the network 110. Offensive security techniques may be used by pentesters (e.g., “red teams”) to identify security vulnerabilities in the network 110 and proactively improve network security. In some cases, offensive security techniques may be defined by an attack framework (e.g., a MITRE ATT&CK® framework).

The autonomous pentesting agent 105 may perform an autonomous pentest by using the offensive security techniques. For example, the autonomous pentesting agent 105 may combine (e.g., “chain”) one or more offensive security techniques and exploit the network 110 during a pentest. By using the offensive security techniques during the pentest, the autonomous pentesting agent 105 may identify or demonstrate security vulnerabilities in the network 110. That is, during an autonomous pentest, the autonomous pentesting agent 105 may compromise assets including the network asset 305-a, the network asset 305-b, the network asset 305-c, or any combination thereof.

The network assets 305 may be examples of one or more devices, systems, or other entities that may be accessed to compromise the network. For example, the network assets 305 may be examples of physical machines, virtual machines, containers, network shares, cloud resources (e.g., buckets), databases, or the like. In some examples, a network asset, if accessed or obtained, may enable access to one or more other network assets. In the example of FIG. 3, the network asset 305-a may enable access to the network asset 305-b and the network asset 305-c. As an example, the network asset 305-a may be a credential or access key that is used to access an application or a service. Such a relationship between access of different network assets may be referred to herein as network assets being “upstream” or “downstream.” That is, the network asset 305-a may be upstream from the network asset 305-b and the network asset 305-c.

The autonomous pentesting agent 105, during an autonomous pentest, may attempt to compromise the network assets 305. As used herein, “compromise” may refer to gaining write access. That is, the autonomous pentesting agent 105 may compromise the network asset 305-a by gaining write access to the network asset 305-a. By gaining write access (e.g., by compromising the assets), the autonomous pentesting agent 105 may be enabled to place tripwires. In other words, the autonomous pentesting agent 105, after compromising an asset, may place a tripwire by modifying the asset (e.g., using the write access) to incorporate or otherwise deploy the tripwire. The autonomous pentesting agent 105 may compromise network assets by exploiting a misconfiguration or vulnerability of the asset or by compromising credentials that allow write access to the asset, among other examples.

In some examples, the autonomous pentesting agent 105 may compromise one or more network assets by first compromising an upstream asset. That is, the autonomous pentesting agent 105 may compromise the network asset 305-a and, subsequently, use the write access to the network asset 305-a to compromise the network asset 305-b, the network asset 305-c, or both. In other words, the autonomous pentest may involve a multi-step process in which compromising one asset may yield data, credentials, or access that leads to or enables compromising another asset, and so on. Multi-step compromising of assets may be referred to as “chaining” and “pivoting.” Alternatively, the downstream assets may be accessed independently from upstream assets (e.g., without accessing upstream assets first, such as accessed directly). In some examples, the autonomous pentesting agent 105 may install implants on the network assets 305 after compromising. As an example, the autonomous pentesting agent 105 may install a RAT on a host after compromising the host, which the autonomous pentesting agent 105 may use to perform post-exploitation activities (e.g., credential dumping).

The autonomous pentesting agent 105 may include one or more components or subcomponents to perform the autonomous pentest and, during the autonomous pentest, deploy tripwires. For example, the autonomous pentesting agent 105 may include a test component, a tripwire controller component, a tripwire generator component, a tripwire dropper component, and a tripwire detector component. The different components may refer to different functions or tasks performed by the autonomous pentesting agent 105.

The autonomous pentesting agent 105, using the test component, may be configured to perform the autonomous pentest. For example, the autonomous pentesting agent 105 may be configured with a scope of assets to test. As an example, the autonomous pentesting agent 105 may be configured to test one or more network assets, including a single asset, an entire network 110 (e.g., multiple assets, such as tens of thousands of hosts), a subset of the network 110, and so on. The network assets 305 may reside inside the network 110 (e.g., on-premises network), on a cloud network, on a hybrid cloud network, or the like. In some examples, the autonomous pentesting agent 105 may perform the autonomous pentest for one or more networks (e.g., the network 110 and an associated or connected cloud network).

The autonomous pentesting agent 105 may be configured with different TTPs. That is, the autonomous pentest may execute different types of TTPs, including a relatively wide range of TTPs or a relatively targeted range of TTPs (e.g., targeting different security vulnerabilities). As an example, when a new type of vulnerability is revealed in the network 110, the autonomous pentest may execute a relatively targeted range of TTPs to test that new type of vulnerability throughout the network 110 (e.g., prior to mass exploitation of the vulnerability). In some examples, the autonomous pentest may execute a TTP based on a previously performed pentest, such as to test whether deployed security measures (e.g., including tripwires) are improving the security level of the network 110.

The autonomous pentesting agent 105 may identify which assets may be subject to the new type of vulnerability based on one or more previous pentests, including based on asset characteristics collected from previous pentests. Combinations of asset characteristics may uniquely identify a given asset, and, accordingly, may be referred to as asset fingerprints. During previous pentests of the network 110, the autonomous pentesting agent 105 may identify and store asset fingerprints. The autonomous pentesting agent 105 may use the stored asset fingerprints when new types of vulnerabilities are identified after the previous pentests (e.g., identified based on pentesting other networks, published in a common vulnerabilities and exposures (CVE) database or other cybersecurity resource, etc.). Combinations of asset characteristics that may make up asset fingerprints include one or more of: a hostname, a network basic input/output system (NetBIOS) name, a media access control (MAC) address, an internet protocol (IP) address, a machine identifier, a virtual host, a virtual machine identifier, a subnet, a lightweight directory access protocol (LDAP) host name, a cloud instance identifier, a resource identifier, a set of services, open ports, a certificate name, a secure sockets layer (SSL) certificate, a set of file shares, a set of applications associated with a host, application data, an operating system associated with the host, a flag associated with the host, pentest configuration attributes for a previous pentest that identified the host, or any combination thereof.

The autonomous pentesting agent 105 may compare characteristics that define assets susceptible to the new type of vulnerability to the stored asset fingerprints obtained from a prior autonomous pentest of the network 110 and identify which assets have full or partial matches to the susceptible assets. The autonomous pentesting agent 105 may, during the autonomous pentest, attempt to exploit the new type of vulnerability in the identified assets. If the autonomous pentesting agent 105 compromises the identified assets, the autonomous pentesting agent 105 may place a tripwire on the compromised assets. In other words, the autonomous pentesting agent 105 may identify new types of vulnerabilities in the network 110 and “patch” assets that may be subject to those vulnerabilities in parallel with, and concurrent to, attempts to target and compromise those assets as part of the pentesting process.

The autonomous pentesting agent 105 may perform the autonomous pentest internally or externally. That is, the autonomous pentesting agent 105 may be deployed to a device or system within the network 110 (e.g., in an internal network, such as an on-premises network or a cloud network) or to a device or system that accesses the network 110 via an external network, such as via the external network 155 as described with reference to FIG. 1. An external pentest may test assets that are exposed publicly (e.g., via the Internet). In the example of FIG. 3, the network 110 may be understood to be an internal network or an external network, and the network assets 305 may be understood to be assets that are accessible within the network (e.g., internally, private assets, etc.) or accessible through an external network (e.g., public-facing, available through the Internet, etc.).

The autonomous pentest may involve gathering information about environmental factor(s) 310 and compromising assets. For example, the autonomous pentesting agent 105 may, during the autonomous pentest, identify the environmental factor(s) 310 of the network assets 305 (e.g., gather context, reconnaissance). By identifying the environmental factor(s) 310, the autonomous pentesting agent 105 may generate tripwires that are in accordance with or are convincing as an actual network asset within their environment. That is, the autonomous pentesting agent 105 may use the environmental factor(s) 310 to generate tripwires having characteristics that are in accordance with the environment of the network asset on which they are placed. Additionally, the autonomous pentesting agent 105, during the autonomous pentest, may compromise the network assets 305. In some examples, the autonomous pentesting agent 105 may implant compromised hosts with an implant or a RAT.

The autonomous pentest may follow one or more attack paths. For example, the autonomous pentest may follow attack paths that may be illustrated on an autonomous pentest map, such as the autonomous pentest map 200 as described with reference to FIG. 2. As an example, an attack path may include discovery of unauthenticated, anonymous, or guest access to a server message block (SMB) network share, network file system (NFS), or a file transfer protocol (FTP) with write privileges. The autonomous pentesting agent 105 may identify anonymous access to a bucket (e.g., an S3 bucket) with write access. In another example, the attack path may include discovery of a perimeter (e.g., Internet-facing) asset that is vulnerable to unauthenticated remote code execution. The autonomous pentesting agent 105 may exploit the vulnerability to install an implant on the host and dump credentials. The autonomous pentesting agent 105 may identify other hosts on the internal network and use the credentials (e.g., the dumped credentials) to log in to other hosts in the internal network. In yet another example, the attack path may include compromising a user account via a password spray attack. The autonomous pentesting agent may compromise assets connected to the user, including hosts that the user has privileges to log in to, network shares the user has access to, an email inbox of the user, knowledgebases, and collaboration platforms.

The autonomous pentesting agent 105 may determine which assets tripwires are to be deployed to. For example, the autonomous pentesting agent 105 may select one or more assets that are compromised during the autonomous pentest to deploy tripwires to. In other words, the autonomous pentesting agent 105 may select network assets for tripwire deployment from one or more network assets that are compromised by the autonomous pentesting agent 105. In some examples, the autonomous pentesting agent 105 may deploy tripwires to all compromised network assets. That is, in examples in which relatively few assets are compromised, the autonomous pentesting agent 105 may deploy tripwires to all the compromised network assets.

In some other examples, the autonomous pentesting agent 105 may deploy tripwires to a subset of the compromised assets. The autonomous pentesting agent 105 may determine a prioritization of the compromised assets. The prioritization may be based on the environmental factor(s) 310. For example, the autonomous pentesting agent 105 may prioritize network assets that are at more frequently visited locations, connected to multiple other devices or systems, or the like. High priority assets may be referred to as “crown jewel” assets. The high priority assets, in some examples, may be data repositories, centralized points of communication (e.g., virtual private networks), or the like. The autonomous pentesting agent 105 may prioritize the compromised assets based on fingerprinting network services exposed on the compromised assets, identifying types of software installed on the compromised assets (e.g., compromised hosts), identifying running processes on the compromised assets (e.g., compromised hosts), or the like. Additionally, the autonomous pentesting agent 105 may prioritize the compromised assets based on network traffic (e.g., to identify “hubs” and “spokes”). As an example, the autonomous pentesting agent 105 may prioritize the network asset 305-a over the network asset 305-b or the network asset 305-c based on the network asset 305-a enabling access to (e.g., being upstream from) the other network assets.

The autonomous pentesting agent 105 may prioritize the compromised assets based on user input. For example, a user may configure the autonomous pentesting agent 105 with one or more parameters prior to the autonomous pentest, between different autonomous pentests, during autonomous pentests, or any combination thereof. User inputs may indicate priorities associated with one or more network assets. As an example, a user input may identify that the network asset 305-a is associated with a high priority level. In such an example, the autonomous pentesting agent 105 may deploy a tripwire to the network asset 305-a based on the network asset 305-a being compromised during an autonomous pentest and the user input indicating that the network asset 305-a has a high priority level. Additionally, or alternatively, the autonomous pentesting agent 105 may deploy tripwires leading to the network asset 305-a (e.g., upstream from the network asset 305-a).

The autonomous pentesting agent 105 may generate tripwires using the environmental factor(s) 310, user inputs, or both. For example, the autonomous pentesting agent 105 may generate different tripwire types based on the environmental factor(s) 310 or user inputs. Examples of tripwire types may include credential-based tripwires, database dump tripwires, business document tripwires, and email inboxes or knowledgebases tripwires.

A credential-based tripwire may include a username and password combination or access key. The username may match a name of a user in the environment (e.g., identified as an environmental factor). One or more attacker methods may be used to enumerate usernames within an environment. For instance, in a directory setup, any domain user may be used to dump a list of all other users. In some examples, the autonomous pentesting agent 105 may dump the list of all other users anonymously by exploiting misconfigurations (e.g., an SMB null session). In another example, the credential-based tripwire may be based on the home directories on a host. For example, usernames may be identified in a folder of the home directories (e.g., in a C:\Users folder). In some host types, a password or home directory may be identified for existing users (e.g., an /etc/password or /home directory).

A database dump tripwire may be generated to appear as a database. For example, the database may appear as contents of another database in the network 110. In examples in which an autonomous pentest compromises a database, a schema from the database may be extracted and filled in with a combination of real data and synthetic data to create a tripwire.

A business document tripwire may include or appear to include sensitive data, such as the sensitive data 150 as described with reference to FIG. 1. Business documents discovered during the autonomous pentest may be used to generate a business document tripwire. For instance, in examples in which the autonomous pentest identifies a real business document with personally identifiable information (PII) or payment card industry (PCI) data, the autonomous pentesting agent 105 may generate a tripwire by redacting the sensitive content and replacing it with synthetic data. This synthetic data may be made more convincing by including fake data about real users in the environment (e.g., using identified credentials or directories in the network 110). Alternatively, the autonomous pentesting agent 105 may use one or more AI models (e.g., a generative AI approach) to create a new business document based on a corpus of compromised documents. A file name of the business document may also be synthesized using the one or more AI models to incorporate filenames of business documents identified during the autonomous pentest or using prepended or appended characters to a file name of an existing document.

An email inbox or knowledgebase tripwire may be generated similarly to the business document tripwire. For example, the email inbox or knowledgebase tripwire may include real or synthetic information, use one or more AI models to generate synthetic information or documents, and be based on environmental factor(s) 310 identified during autonomous pentests.

In addition to generating the tripwires, the autonomous pentesting agent 105 may determine one or more locations on network assets 305 where the tripwire may be deployed in accordance with the type of tripwire. For instance, a credential-based tripwire may appear in a home directory of a user. Accordingly, the autonomous pentesting agent 105 may deploy the credential-based tripwire under C:\users\<username>or /home/<username>. The autonomous pentesting agent 105 may identify or determine a prioritization of the one or more locations. In such examples, the autonomous pentesting agent 105 may deploy the tripwires in accordance with the prioritization. As an example, if the autonomous pentesting agent 105 fails to place a tripwire at a first location, the autonomous pentesting agent 105 may move to a next prioritized location. Additionally, or alternatively, the autonomous pentesting agent 105 may determine the one or more locations based on feedback from one or more autonomous pentests (e.g., performed during deployment of the tripwires or prior).

The autonomous pentesting agent 105 may place tripwires on the network assets 305. As an example, the autonomous pentesting agent 105 may place a tripwire 315-a on a network asset 305-a, a tripwire 315-b on a network asset 305-b, and a tripwire 315-c on a network asset 305-c. The autonomous pentesting agent 105 may place the tripwires based on the type of tripwire and the network assets 305. For example, the autonomous pentesting agent 105 may deploy the tripwires to the different network assets using different deployment techniques based on the tripwire types, types of network assets, and environmental factor(s) 310. The different deployment techniques may be associated with different file sharing protocols, including SMB, NFS, FTP, or the like. Additionally, or alternatively, different deployment techniques may involve different protocols that support management access, including secure shell (SSH), SMB, Windows management instrumentation (WMI), Windows remote management (WinRM), or using a previously installed implant or RAT. Deploying the tripwires do the different network assets may involve compliance with communication protocols or application programming interfaces (APIs) of the different network assets.

The autonomous pentesting agent 105 may, after deploying the tripwires, detect when a tripwire is triggered (e.g., “tripped). The autonomous pentesting agent 105 may include or support tripwire detection infrastructure, which may be cloud-based or hosted on-premises (e.g., based on the type of tripwire). Different types of tripwires may be triggered differently. In other words, triggering events may be different for different types of tripwires. As an example, a credential-based tripwire may be tripped when credentials in the credential-based tripwire are used in an account log. In another example, a business document tripwire may be tripped when opened, or a database dump file may be detected using a domain name system (DNS) based callback.

After the tripwire is triggered, the autonomous pentesting agent 105 may transmit an alert. For example, the autonomous pentesting agent 105 may notify a user via messaging channels (e.g., email) or using webhooks that communicate with a centralized monitoring infrastructure.

The autonomous pentesting agent 105 may place multiple tripwires on a single asset based on the type of asset or attack paths that lead to compromising the asset. As an example, during an autonomous pentest, the autonomous pentesting agent 105 may identify that an asset exposes a network share with write privileges. The autonomous pentesting agent 105 may place credential-based tripwire within this network share. During the same autonomous pentest, the asset may be compromised, and the autonomous pentesting agent 105 may deploy an implant with administrative privileges. The implant may identify a database running locally on the machine and create a database dump tripwire using the schema dumped from the database. The database dump tripwire may be placed on the asset in a different location than the exposed network share, and the database dump tripwire may be accessible based on the host being compromised.

In other words, the autonomous pentesting agent 105 may place multiple tripwires on a single asset in examples in which multiple security vulnerabilities exist at the single asset. That is, the asset may be exploited in multiple ways. As an example, a Linux box may be vulnerable to a remote code execution and run with default SSH credentials, which may both be exploited and lead to access as different users on a host. Accordingly, the autonomous pentesting agent 105 may place tripwires on the host for the different users (e.g., accessible to or from the perspective of different users).

In some examples, the autonomous pentesting agent 105 may trip on tripwires planted during the autonomous pentest or planted during a previous pentest. A backend of the autonomous pentesting agent 105 may maintain a standing reference of tripwires planted during the test and previous tests. The reference may include data uniquely identifying each tripwire that was placed. As an example, for file-based tripwires, the backend may store a hash of the file (e.g., a message-digest algorithm 5 (MD5 ), secure hash algorithm 1 (SHA1 ), SHA 2(SHA2 ), etc.), or the raw contents of the file itself. When the autonomous pentesting agent 105 encounters an resource on the network, the autonomous pentesting agent 105 may first validate whether the resource is a tripwire using the backend of tripwires before applying attacker TTPs against this resource.

The tripwire deployment may, in some examples, involve user input. For example, a user (e.g., human operator) may review results of an autonomous pentest and provide user inputs indicating tripwire types, tripwire locations, or both that are used in a subsequent autonomous pentest. That is, the autonomous pentesting agent 105 may perform the subsequent autonomous pentest, which may involve repeating a same sequence of steps as the initial autonomous pentest or directly accessing and planting the tripwires using credentials provided by the user. In another example, the user may approve request messages from the autonomous pentesting agent 105 to deploy tripwires in real-time (e.g., while the autonomous pentest is being performed).

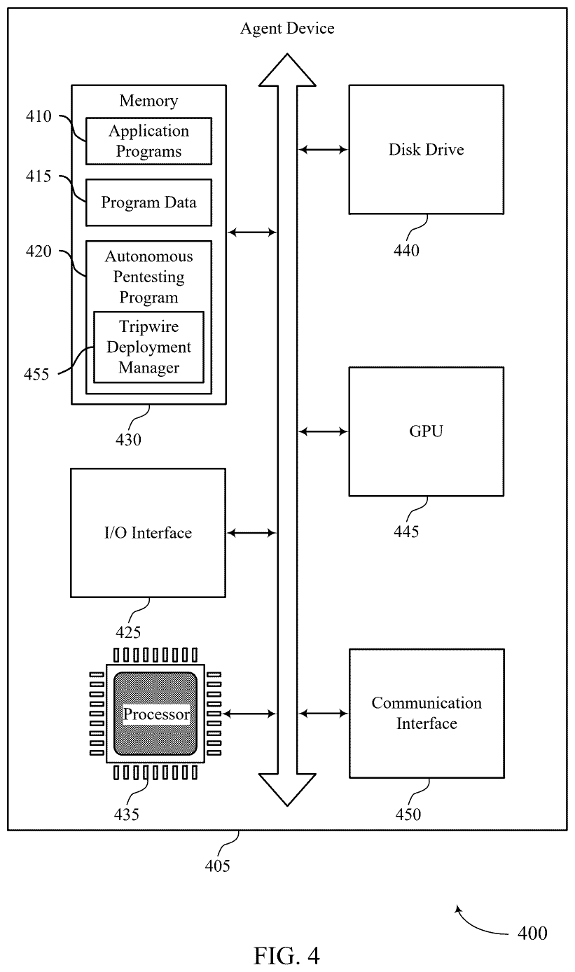

FIG. 4 shows a diagram of a system 400 including an agent device 405 that supports autonomous tripwire deployment during network pentesting in accordance with aspects of the present disclosure. The agent device 405 may be an example of a device or server on which an autonomous pentesting agent 105 is deployed as described herein. The agent device 405 may include components for autonomous tripwire deployment, such as a memory 430 including application programs 410, program data 415, an autonomous pentesting program 420, and a tripwire deployment manager 455; an input/output (I/O) interface 425; a processor 435; a disk drive 440; a graphics processing unit (GPU) 445; and a communication interface 450. Each of these components may communicate, directly or indirectly, with one another (e.g., via one or more buses, communications links, communications interfaces, or any combination thereof).

The I/O interface 425 may support connection of the agent device 405 with one or more other devices. For example, the agent device 405 may connect to keyboards, mice, printers, hard disks, or the like via the I/O interface 425. The I/O interface 425 may communicate with the processor 435. That is, the processor 435 may process signals from devices connected to the agent device 405 via the I/O interface 425.

Memory 430 may include RAM, ROM, or both. The memory 430 may store computer-readable, computer-executable software including instructions that, when executed, cause at least one processor 435 to perform various functions described herein, such as functions supporting autonomous tripwire deployment during network pentesting. In some cases, the memory 430 may contain, among other things, a basic input/output system (BIOS), which may control basic hardware or software operation such as the interaction with peripheral components or devices. The memory 430 may be an example of a single memory or multiple memories. For example, the agent device 405 may include one or more memories 430.

The application programs 410 in the memory 430 may be examples of app(s) 140 as described with reference to FIG. 1. For example, the application programs 410 may be installed on the memory 430 of the agent device 405, among other devices in a network. The application programs 410 may be examples of software applications or computer programs that are implemented to carry out one or more functions or tasks.

The program data 415 may be data related to the application programs 410. Program data 415 may be an example of or refer to running data of programs and applications installed on the memory 430 of the agent device 405. In some examples, the program data 415 may include various data, including code that allows the application programs 410 to perform the one or more functions or tasks.

The processor 435 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 435 may be configured to execute computer-readable instructions stored in at least one memory 430 to perform various functions (e.g., functions or tasks supporting autonomous tripwire deployment during network pentesting). Though a single processor 435 is depicted in the example of FIG. 4, it is to be understood that the system 400 may include any quantity of one or more of processors 435 and that a group of processors 435 may collectively perform one or more functions ascribed herein to a processor, such as the processor 435. The processor 435 may be an example of a single processor or multiple processors. For example, the agent device 405 may include one or more processors 435.

The disk drive 440 may be configured to store data that is generated, processed, stored, or otherwise used by the system 400. In some cases, the disk drive 440 may include one or more hard disk drives (HDDs), one or more solid-state drives (SSDs), or both. In some examples, the disk drive 440 may be an example of a single database, a distributed database, multiple distributed databases, a data store, a data lake, or an emergency backup database. In some examples, the disk drive 440 may be an example of one or more components described with reference to FIG. 1.

GPU 445 may be configured to store graphics-related data. The GPU 445 may store and manage data related to graphics and video processing. In some examples, the GPU 445 may be an example of or a component of a graphics card. The GPU 445 may use components of the memory 430, including the RAM, for temporary storage. For example, the GPU 445 may move data from the RAM of the memory 430 to the GPU 445 for graphics and video processing.

The communication interface 450 may enable the agent device 405 to exchange information (e.g., input information, output information, or both) with other systems or devices (not shown). For example, the communication interface 450 may enable the agent device 405 to connect to a network (e.g., a network 110 as described herein). The communication interface 450 may include one or more wireless network interfaces, one or more wired network interfaces, or any combination thereof.

The autonomous pentesting program 420 may be an example of a program of an autonomous pentesting service that is installed on the memory 430 of the agent device 405. The autonomous pentesting program 420 may execute an autonomous pentest of a network accessed by the agent device 405, such as accessed via the communication interface 450. That is, the autonomous pentesting program 420 may be configured to perform an autonomous pentest as described herein, including an autonomous pentest involving autonomous deployment of tripwires.

The tripwire deployment manager 455 may support tripwire deployment in accordance with examples as disclosed herein. For example, the tripwire deployment manager 455 may be configured as or otherwise support a means for executing an autonomous pentest of a network of network assets, where executing the autonomous pentest includes identifying in real-time one or more network assets within the network to which one or more tripwires are to be deployed. The tripwire deployment manager 455 may be configured as or otherwise support a means for deploying, during the autonomous pentest, the one or more tripwires to the one or more network assets within the network based at least in part on one or more environmental factors of the one or more network assets detected during the autonomous pentest. The tripwire deployment manager 455 may be configured as or otherwise support a means for detecting, after deploying the one or more tripwires, occurrence of a triggering event at a tripwire of the one or more tripwires. The tripwire deployment manager 455 may be configured as or otherwise support a means for reporting the occurrence of the triggering event based at least in part on the detection.

By including or configuring the tripwire deployment manager 455 in accordance with examples as described herein, the agent device 405 may support techniques for improved network security.

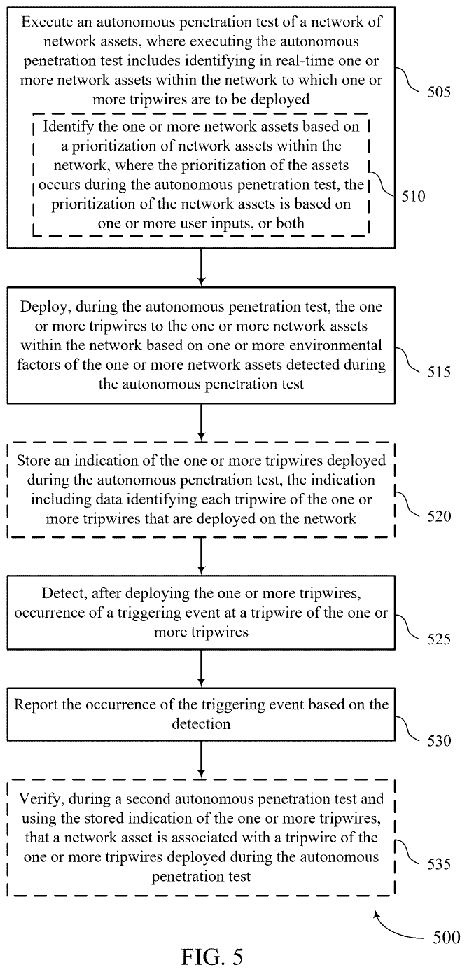

FIG. 5 shows a flowchart illustrating a method 500 that supports autonomous tripwire deployment during network pentesting in accordance with aspects of the present disclosure. The operations of the method 500 may be implemented by an agent device 405 or its components as described herein. In some examples, an agent device may execute a set of instructions to control the functional elements of the agent device to perform the described functions. Additionally, or alternatively, the agent device may perform aspects of the described functions using special-purpose hardware.

At 505, the method may include executing an autonomous pentest of a network of network assets, where executing the autonomous pentest includes identifying in real-time one or more network assets within the network to which one or more tripwires are to be deployed.

In some examples, at 510, identifying the one or more network assets may include identifying the one or more network assets based on a prioritization of network assets within the network, where the prioritization of the assets occurs during the autonomous pentest, the prioritization of the network assets is based on one or more user inputs, or both.

At 515, the method may include deploying, during the autonomous pentest, the one or more tripwires to the one or more network assets within the network based on one or more environmental factors of the one or more network assets detected during the autonomous pentest.

In some examples, at 520, the method may include storing an indication of the one or more tripwires deployed during the autonomous pentest, the indication including data identifying each tripwire of the one or more tripwires that are deployed on the network.

At 525, the method may include detecting, after deploying the one or more tripwires, occurrence of a triggering event at a tripwire of the one or more tripwires.

At 530, the method may include reporting the occurrence of the triggering event based at least in part on the detection.

In some examples, at 535, the method may include verifying, during a second autonomous pentest and used the stored indication of the one or more tripwires, that a network asset is associated with a tripwire of the one or more tripwires deployed during the autonomous pentest.

The following provides an overview of aspects of the present disclosure:

Aspect 1: A method for tripwire deployment, comprising: executing an autonomous pentest of a network of computer assets, wherein executing the autonomous pentest includes identifying in real-time one or more network assets within the network to which one or more tripwires are to be deployed; deploying, during the autonomous pentest, the one or more tripwires to the one or more network assets within the network based at least in part on one or more environmental factors of the one or more network assets detected during the autonomous pentest; detecting, after deploying the one or more tripwires, occurrence of a triggering event at a tripwire of the one or more tripwires; and reporting the occurrence of the triggering event based at least in part on the detection.

Aspect 2: The method of aspect 1, further comprising: identifying the one or more network assets based at least in part on a prioritization of network assets within the network, wherein the prioritization of the assets occurs during the autonomous pentest, the prioritization of the network assets is based at least in part on one or more user inputs, or both.

Aspect 3: The method of aspect 2, wherein the prioritization of the one or more network assets within the network is based at least in part on a relative risk or an impact factor associated with each network asset of the one or more network assets.

Aspect 4: The method of aspect 3, wherein the one or more environmental factors of the one or more network assets indicate the relative risk or the impact factor associated with each network asset of the one or more network assets.

Aspect 5: The method of aspect 4, wherein the one or more environmental factors include one or more of a sensitivity of information stored by or associated with the one or more network assets, a quantity of network assets downstream from the one or more network assets in the network, a security policy associated with the one or more network assets, a compromised status of the one or more network assets during the autonomous pentest, or any combination thereof.

Aspect 6: The method of any of aspects 1 through 5, wherein deploying the one or more tripwires further comprises: deploying the one or more tripwires using one or more file sharing protocols that are in accordance with the one or more network assets, wherein: the one or more file sharing protocols comprise an SMB protocol, a NFS, an FTP, or any combination thereof.

Aspect 7: The method of any of aspects 1 through 6, further comprising: storing an indication of the one or more tripwires deployed during the autonomous pentest, the indication comprising data identifying each tripwire of the one or more tripwires that are deployed on the network; and verifying, during a second autonomous pentest and using the stored indication of the one or more tripwires, that a network asset is associated with a tripwire of the one or more tripwires deployed during the autonomous pentest.

Aspect 8: The method of any of aspects 1 through 7, further comprising: receiving, after executing an initial autonomous pentest that is before the autonomous pentest, one or more user inputs that indicate one or more second tripwires to be deployed; and executing the autonomous pentest after deploying the one or more second tripwires according to the one or more user inputs, wherein the one or more tripwires are different than the one or more second tripwires.

Aspect 9: The method of any of aspects 1 through 8, further comprising: receiving, during the autonomous pentest, one or more user inputs that approve deployment of the one or more tripwires.

Aspect 10: The method of any of aspects 1 through 9, further comprising: determining a configuration comprising a tripwire folder location, a tripwire file name, or both for a tripwire of the one or more tripwires, wherein the tripwire is deployed to a respective network asset of the one or more network assets in accordance with the configuration.

Aspect 11: The method of any of aspects 1 through 10, further comprising: executing the autonomous pentest in accordance with a scope that defines at least the one or more network assets of the network to be tested, wherein the scope is identified based at least in part on one or more user inputs.

Aspect 12: The method of any of aspects 1 through 11, wherein the autonomous pentest is executed using one or more AI models of an autonomous pentesting agent.

Aspect 13: The method of aspect 12, wherein the one or more network assets to which the one or more tripwires are to be deployed are identified via the one or more AI models.

Aspect 14: The method of any of aspects 12 through 13, further comprising: training the one or more AI models of the autonomous pentesting agent using training data generated from a plurality of autonomous pentests, wherein the autonomous pentest is executed using the one or more trained AI models.

Aspect 15: The method of any of aspects 1 through 14, wherein the identification, during the autonomous pentest, of the one or more network assets to which the one or more tripwires are deployed is associated with a higher security level of the network compared to a hard-coded pentest of the network.

Aspect 16: The method of any of aspects 1 through 15, wherein identifying the one or more network assets further comprises: identifying one or more tripwire types of the one or more tripwires, the one or more tripwire types based at least in part on the one or more environmental factors of the one or more network assets.

Aspect 17: The method of aspect 16, wherein a tripwire type of the one or more tripwire types comprises a credential-based tripwire, wherein: the credential-based tripwire is based at least in part on a user directory identified during the autonomous pentest.

Aspect 18: The method of any of aspects 16 through 17, wherein a tripwire type of the one or more tripwire types comprises a database dump tripwire, wherein: the database dump tripwire comprises real data of the network that is obtained during the autonomous pentest, synthetic data generated based at least in part on the autonomous pentest, or both.

Aspect 19: The method of any of aspects 16 through 18, wherein a tripwire type of the one or more tripwire types comprises a business document tripwire, wherein: the business document tripwire comprises synthetic PII or synthetic PCI data, and the business document tripwire, the synthetic PII, the synthetic PCI, or any combination thereof are generated based at least in part on the autonomous pentest.

Aspect 20: The method of any of aspects 16 through 19, further comprising: identifying one or more network locations of the one or more network assets in accordance with the one or more tripwire types, wherein the one or more tripwires are deployed at the identified one or more network locations.

Aspect 21: The method of any of aspects 1 through 20, further comprising: identifying a type of security vulnerability that is not included in a previous autonomous pentest executed prior to the autonomous pentest; and executing the autonomous pentest of one or more network assets of the network of network assets that are vulnerable to the type of security vulnerability, wherein the one or more network assets are identified as vulnerable to the type of security vulnerability in accordance with one or more asset characteristics collected from the previous autonomous pentest.

Aspect 22: The method of any of aspects 1 through 21, further comprising: generating the one or more tripwires based at least in part on one or more user inputs.

Aspect 23: The method of any of aspects 1 through 22, wherein executing the autonomous pentest comprises: executing one or more defined attacker TTPs that compromise the one or more network assets within the network.

Aspect 24: The method of any of aspects 1 through 23, wherein the autonomous pentest is executed within the network or via one or more externally-exposed assets of the network.

Aspect 25: The method of any of aspects 1 through 24, wherein the autonomous pentest is executed with or without user credentials of a user of an organization.

Aspect 26: An apparatus for tripwire deployment, comprising one or more memories storing processor-executable code, and one or more processors coupled with the one or more memories and individually or collectively operable to execute the code to cause the apparatus to perform a method of any of aspects 1 through 25.

Aspect 27: An apparatus for tripwire deployment, comprising at least one means for performing a method of any of aspects 1 through 25.

Aspect 28: A non-transitory computer-readable medium storing code for tripwire deployment, the code comprising instructions executable by one or more processors to perform a method of any of aspects 1 through 25.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for tripwire deployment, comprising:
executing an autonomous penetration test of a network of network assets, wherein executing the autonomous penetration test includes identifying in real-time one or more network assets within the network to which one or more tripwires are to be deployed;
deploying, during the autonomous penetration test, the one or more tripwires to the one or more network assets within the network based at least in part on one or more environmental factors of the one or more network assets detected during the autonomous penetration test;
detecting, after deploying the one or more tripwires, occurrence of a triggering event at a tripwire of the one or more tripwires; and
reporting the occurrence of the triggering event based at least in part on the detection.

2. The method of claim 1, further comprising:
identifying the one or more network assets based at least in part on a prioritization of network assets within the network, wherein the prioritization of the assets occurs during the autonomous penetration test, the prioritization of the network assets is based at least in part on one or more user inputs, or both.

3. The method of claim 2, wherein the prioritization of the one or more network assets within the network is based at least in part on a relative risk or an impact factor associated with each network asset of the one or more network assets.

4. The method of claim 3, wherein the one or more environmental factors of the one or more network assets indicate the relative risk or the impact factor associated with each network asset of the one or more network assets.

5. The method of claim 4, wherein the one or more environmental factors include one or more of a sensitivity of information stored by or associated with the one or more network assets, a quantity of network assets downstream from the one or more network assets in the network, a security policy associated with the one or more network assets, a compromised status of the one or more network assets during the autonomous penetration test, or any combination thereof.

6. The method of claim 1, further comprising:
storing an indication of the one or more tripwires deployed during the autonomous penetration test, the indication comprising data identifying each tripwire of the one or more tripwires that are deployed on the network; and
verifying, during a second autonomous penetration test and using the stored indication of the one or more tripwires, that a network asset is associated with a tripwire of the one or more tripwires deployed during the autonomous penetration test.

7. The method of claim 1, further comprising:
receiving, after executing an initial autonomous penetration test that is before the autonomous penetration test, one or more user inputs that indicate one or more second tripwires to be deployed; and
executing the autonomous penetration test after deploying the one or more second tripwires according to the one or more user inputs, wherein the one or more tripwires are different than the one or more second tripwires.

8. The method of claim 1, wherein the autonomous penetration test is executed using one or more artificial intelligence (AI) models of an autonomous penetration testing agent.

9. The method of claim 8, wherein the one or more network assets to which the one or more tripwires are to be deployed are identified via the one or more AI models.

10. The method of claim 8, further comprising:
training the one or more AI models of the autonomous penetration testing agent using training data generated from a plurality of autonomous penetration tests, wherein the autonomous penetration test is executed using the one or more trained AI models.

11. The method of claim 1, wherein identifying the one or more network assets further comprises:
identifying one or more tripwire types of the one or more tripwires, the one or more tripwire types based at least in part on the one or more environmental factors of the one or more network assets.

12. The method of claim 11, wherein a tripwire type of the one or more tripwire types comprises a credential-based tripwire, wherein:
the credential-based tripwire is based at least in part on a user directory identified during the autonomous penetration test.

13. The method of claim 11, wherein a tripwire type of the one or more tripwire types comprises a business document tripwire, wherein:
the business document tripwire comprises synthetic personally identifiable information (PII) or synthetic payment card industry (PCI) data, and
the business document tripwire, the synthetic PII, the synthetic PCI, or any combination thereof are generated based at least in part on the autonomous penetration test.

14. The method of claim 1, further comprising:
identifying a type of security vulnerability that is not included in a previous autonomous penetration test executed prior to the autonomous penetration test; and
executing the autonomous penetration test of one or more network assets of the network of network assets that are vulnerable to the type of security vulnerability, wherein the one or more network assets are identified as vulnerable to the type of security vulnerability in accordance with one or more asset characteristics collected from the previous autonomous penetration test.

15. An apparatus for tripwire deployment, comprising:
one or more memories storing processor-executable code; and
one or more processors coupled with the one or more memories and individually or collectively operable to execute the code to cause the apparatus to:
execute an autonomous penetration test of a network of computer assets, wherein executing the autonomous penetration test includes identifying in real-time one or more network assets within the network to which one or more tripwires are to be deployed;
deploying, during the autonomous penetration test, the one or more tripwires to the one or more network assets within the network based at least in part on one or more environmental factors of the one or more network assets detected during the autonomous penetration test;
detect, after deploying the one or more tripwires, occurrence of a triggering event at a tripwire of the one or more tripwires; and
report the occurrence of the triggering event based at least in part on the detection.

16. The apparatus of claim 15, wherein the one or more processors are individually or collectively further operable to execute the code to cause the apparatus to:
receive, during the autonomous penetration test, one or more user inputs that approve deployment of the one or more tripwires.

17. The apparatus of claim 15, wherein the one or more processors are individually or collectively further operable to execute the code to cause the apparatus to:
execute the autonomous penetration test in accordance with a scope that defines at least the one or more network assets of the network to be tested, wherein the scope is identified based at least in part on one or more user inputs.

18. The apparatus of claim 15, wherein the one or more processors are individually or collectively further operable to execute the code to cause the apparatus to:
generate the one or more tripwires based at least in part on one or more user inputs.

19. The apparatus of claim 15, wherein, to execute the autonomous penetration test, the one or more processors are individually or collectively operable to execute the code to cause the apparatus to:
execute one or more defined attacker tactics and techniques (TTPs) that compromise the one or more network assets within the network.

20. The apparatus of claim 15, wherein the autonomous penetration test is executed within the network or via one or more externally-exposed assets of the network.
